(19) United States
(12) Patent Application Publication
(10) Pub. No.: US 2012/0141906 A1
(43) Pub. Date: Jun. 7, 2012

(54) ELECTRODE MATERIAL FOR FUEL CELL, FUEL CELL COMPRISING THE SAME AND METHOD OF MANUFACTURING THE FUEL CELL

(75) Inventors: Han Wool Ryu, Seoul (KR); Hong Ryul Lee, Hwaseong (KR); Jae Hyuk Jang, Seoul (KR)

(73) Assignee: SAMSUNG ELECTRO-MECHANICS CO., LTD.

(21) Appl. No.: 13/307,862

(22) Filed: Nov. 30, 2011

(30) Foreign Application Priority Data
Dec. 1, 2010 (KR) 10-2010-0121651

(51) Int. Cl. H01M 8/10; B05D 5/12; H01M 4/86

(52) U.S. Cl. 429/480; 429/533; 429/495; 427/115

(57) ABSTRACT

There are provided an electrode material for a fuel cell, a fuel cell comprising the same, and a method of manufacturing the fuel cell. The electrode material for a fuel cell comprises an electrode base material and spherical polystyrene particles forming pores on the electrode base material through heat treatment. In the case of the electrode material according to an exemplary embodiment of the present invention, the average particle size and content of the spherical polystyrene particles may be controlled to form pores having a uniform size on a sintering body formed of the electrode base material, and the control of the porosity thereof may be facilitated.

### CROSS-REFERENCE TO RELATED APPLICATIONS

This application claims the priority of Korean Patent Application No. 10-2010-0121651 filed on Dec. 1, 2010, in the Korean Intellectual Property Office, the disclosure of which is incorporated herein by reference.

### BACKGROUND OF THE INVENTION

1. Field of the Invention

The present invention relates to an electrode material for a fuel cell, a fuel cell comprising the same, and a method of manufacturing the fuel cell, and more particularly, to an electrode material for a fuel cell capable of improving the efficiency of the fuel cell, a fuel cell comprising the same, and a method of manufacturing the fuel cell.

2. Description of the Related Art

A fuel cell is defined as a cell having a capability of generating current by directly converting the chemical energy of a fuel (hydrogen) into electrical energy. The fuel cell is an energy conversion device allowing for an electrochemical reaction of an oxidant (for example, oxygen) with a gaseous fuel (for example, hydrogen) through an oxide electrolyte to generate electricity. Unlike the existing batteries, the fuel cell has characteristics in that it is supplied with fuel and air from the outside to continually generate electricity.

Types of a fuel cell may be classified according to the electrolyte or fuel utilized therein. Further, an operational temperature of the fuel cell and materials of components thereof may be changed according to the utilized electrolyte.

Types of a fuel cell may include a molten carbonate fuel cell (MCFC) and a solid oxide fuel cell (SOFC), both of which operate at a high temperature, and a phosphoric acid fuel cell (PAFC), an alkaline fuel cell (AFC), a proton exchange membrane fuel cell (PEMFC) and a direct methanol fuel cell (DMFC), all of which operate at a relatively low temperature, or the like.

A solid oxide fuel cell has the characteristics of a solid structure, compatibility with multiple-fuels, and high temperature operability. Due to the characteristics of the solid oxide fuel cell, the solid oxide fuel cell may be a high-performance, clean, and efficient power supply source and is being developed for the generation of various types of power.

The solid oxide fuel cell uses a fuel electrode (anode), an air electrode (cathode), and an electrolyte membrane sandwiched therebetween, as a unit cell, and has a stack structure in which the unit cells are stacked.

In order to improve the efficiency of the solid oxide fuel cell, it is important to increase the porosity and gas permeability of the anode and the cathode that are disposed on both surfaces of the electrolyte membrane.

### SUMMARY OF THE INVENTION

An aspect of the present invention provides an electrode material for a fuel cell capable of improving the efficiency of the fuel cell, a fuel cell including the same, and a method of manufacturing the fuel cell.

According to an aspect of the present invention, there is provided an electrode material for a fuel cell including: an electrode base material; and spherical polystyrene particles forming pores in the electrode base material through heat treatment.

The polystyrene particles may have an average particle size of 2 to 20 μm.

A content of the polystyrene particles may be 5 to 15 parts by weight per 100 parts by weight of the electrode base material.

The electrode base material may be an electrode material for a solid oxide fuel cell.

The electrode base material may be a composite of a metal-ceramic ion conductor.

The electrode base material may be at least one selected from the group consisting of lanthanum strontium manganite (LSM), Ni—YSZ cermet that is a mixture of nickel oxide (NiO) with yttria stabilized zirconia (YSZ), Cu—YSZ cermet, LSM-YSZ cermet, Ni—ScSZ cermet that is a mixture of nickel oxide (NiO) with scandia stabilized zirconia (ScSZ), Cu—ScSZ, Ni-GDC cermet that is a mixture of nickel oxide (NiO) with Gd doped ceria (CeO₂) (GDC), Cu-GDC cermet, and lanthanum strontium cobalt ferrite (LSCF).

The electrode base material may be a powder.

The electrode material for a fuel cell may further include a binder resin.

According to another aspect of the present invention, there is provided a fuel cell including: an electrolyte membrane; an anode electrode and a cathode electrode respectively formed on one surface and the other surface of the electrolyte membrane, wherein at least one of the anode electrode and the cathode electrode is a sintered body formed of an electrode base material having a plurality of pores formed by a combustion of spherical polystyrene particles.

The pores may have an average particle size of 2 to 20 μm.

The sintered body may have a porosity of 15 to 50%.

The electrode base material may be an electrode material of a solid oxide fuel cell.

The electrode base material may be a composite of a metal-ceramic ion conductor.

According to another aspect of the present invention, there is provided a method of manufacturing a fuel cell, the method including: manufacturing a slurry using an electrode material including an electrode base material and spherical polystyrene particles; manufacturing an electrode sheet using the slurry; firing the electrode sheet to form a sintered body of the electrode base material having pores formed by a combustion of the spherical polystyrene particles; and placing the sintered body of the electrode base material on at least one of one surface and the other surface of an electrolyte membrane to be provided as an anode electrode or a cathode electrode.

The polystyrene particles may have an average particle size of 2 to 20 μm.

A content of the polystyrene particle may be 5 to 15 parts by weight per 100 parts by weight of the electrode base material.

The electrode base material may be an electrode material for a solid oxide fuel cell.

The electrode base material may be a composite of a metal-ceramic ion conductor.

The electrode base material may be a powder.

The electrode material may further include a binder resin.

The firing of the electrode sheet may be performed at 1000° C. or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically showing a fuel cell according to an exemplary embodiment of the present invention;

FIG. 2 is a graph showing a pore formation ratio according to a sintering temperature of an electrode material according to an exemplary embodiment of the present invention;

FIG. 3 is a graph showing gas permeability in an electrode formed of an electrode material according to an exemplary embodiment of the present invention; and

FIG. 4A is a scanning electron microscope (SEM) image of an electrode according to an Inventive Example, and FIG. 4B is a scanning electron microscope (SEM) image of an electrode according to a Comparative Example.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components within the same spirit thereof, and those are to be construed as being included in the spirit of the present invention.

Further, throughout the drawings, the same or similar reference numerals will be used to designate the same or like components having the same functions in overall invention.

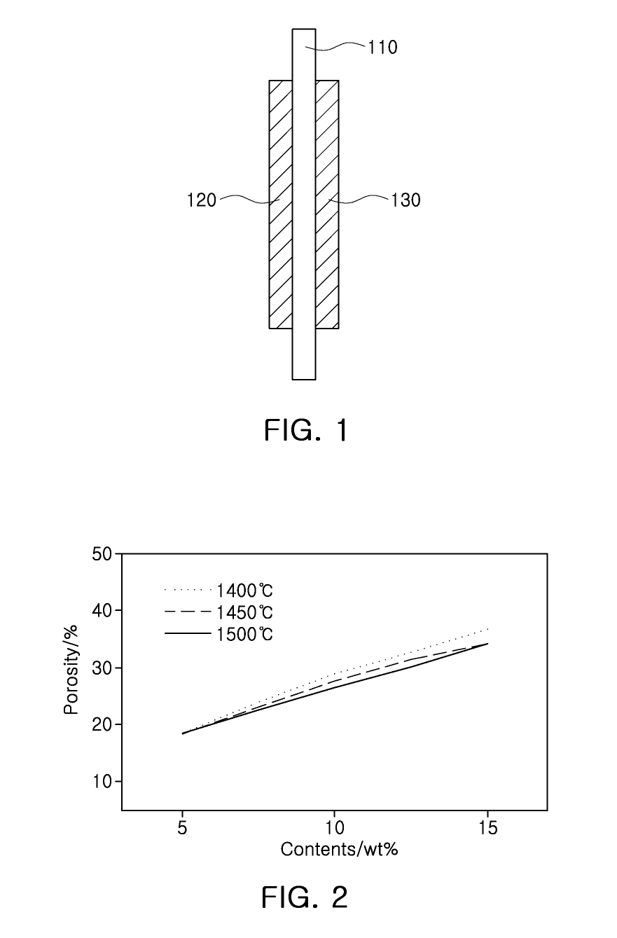

FIG. 1 is a diagram schematically showing a fuel cell according to an exemplary embodiment of the present invention.

A fuel cell according to an exemplary embodiment of the present invention may include an electrolyte membrane 110, and an anode electrode 120 and a cathode electrode 130 formed on one surface and the other surface of the electrolyte membrane, respectively.

Types of a fuel cell according to an exemplary embodiment of the present invention may include a molten carbonate fuel cell (MCFC), a solid oxide fuel cell (SOFC), a phosphoric acid fuel cell (PAFC), an alkaline fuel cell (AFC), a proton exchange membrane fuel cell (PEMFC), a direct methanol fuel cell (DMFC), or the like. Hereinafter, the solid oxide fuel cell will be described by way of example.

The fuel cell includes one electrolyte membrane 110, and the anode and cathode electrodes 120 and 130, respectively formed on both surfaces of the electrolyte membrane, as a unit cell, and may have a stack structure in which a plurality of unit cells are stacked.

The electrolyte membrane 100 may be selected according to the types of a fuel cell. Without being limited thereto, the solid oxide fuel cell may use yttria stabilized zirconia (YSZ) as the electrolyte membrane 110.

The thickness of the electrolyte membrane 110 is not specifically limited. For example, the thickness of the electrolyte membrane 100 may be 1 to 5 μm.

As the electrolyte membrane is thinned, a moving distance of oxygen ion is reduced within the electrolyte, such that ohmic resistance and polarization resistance are reduced; and the contact efficiency and reactivity between the electrolyte membrane and the anode electrode are improved, such that the performance of the unit cells can be improved.

The anode electrode 120 and/or the cathode electrode 130 may be a porous structure. In more detail, the anode electrode 120 and/or the cathode electrode 130 may be a sintered body formed by sintering an electrode base material, in which a plurality of pores formed by the combustion of polystyrene particles may be present in the sintered body. The polystyrene particles have a spherical shape, in which spherical pores are left in the sintered body, formed of the electrode base material, while being removed by heat treatment.

The anode electrode 120 and/or the cathode electrode 130 may be formed of an electrode material for a fuel cell according to an exemplary embodiment of the present invention. A detailed description thereof will be described below.

Oxygen permeating the cathode electrode 130 (hereinafter, also referred to as an “air electrode”) reaches the electrolyte membrane 110, and oxygen ions, generated by a reduction reaction of oxygen, move to the anode electrode 120 (hereinafter, also referred to as a “fuel electrode”) through the electrolyte membrane. The oxygen ions react with hydrogen supplied to the anode electrode, thereby generating water. In this case, electrons are generated from the anode electrode and electrons are consumed in the cathode electrode, such that electricity flows therethrough.

In order to increase the efficiency of the fuel cell, it is important to improve the porosity of the porous cathode and anode electrodes, through which oxygen and hydrogen permeate, and to increase the gas permeability.

The anode electrode 120 and the cathode electrode 130 according to the exemplary embodiment of the present invention have a porous structure, in which the average particle size of a pore may be 2 to 20 μm. In addition, the porosity of the sintered body may be 15 to 50%.

When the average particle size of the pore is below 2 μm, ion conductivity may be degraded, and when the average particle size of the pore exceeds 20 μm, the strength of the electrode structure may be degraded.

The anode electrode 120 and the cathode electrode 130 may be formed of an electrode material for a fuel cell according to an exemplary embodiment of the present invention. Hereinafter, an electrode material for a fuel cell according to an exemplary embodiment of the present invention will be described.

An electrode material for a fuel cell according an exemplary embodiment of the present invention may include an electrode base material and spherical polystyrene particles forming pores in the sintered body of the electrode base material through heat treatment.

As described above, the electrode material for the fuel cell according to the exemplary embodiment of the present invention may be used to manufacture electrodes of the solid oxide fuel cell.

Without being limited thereto, the electrode material may be used to manufacture electrodes of a molten carbonate fuel cell (MCFC), a solid oxide fuel cell (SOFC), a phosphoric acid fuel cell (PAFC), an alkaline fuel cell (AFC), a proton exchange membrane fuel cell (PEMFC), a direct methanol fuel cell (DMFC), or the like.

The electrode base material according to the exemplary embodiment of the present invention is not specifically limited, so long as it can be used as the electrode material of the fuel cell.

In more detail, the electrode base material may use a material used as the anode electrode or the cathode electrode of the solid oxide fuel cell and may use a metal-ceramic ion conductive composite material.

The electrode base material is not specifically limited, and may be lanthanum strontium manganite (LSM), Ni—YSZ cermet that is a mixture of nickel oxide (NiO) with yttria stabilized zirconia (YSZ), Cu—YSZ cermet, LSM-YSZ cermet, Ni—ScSZ cermet that is a mixture of nickel oxide (NiO) with scandia stabilized zirconia (ScSZ), Cu—ScSZ, Ni-GDC cermet that is a mixture of nickel oxide (NiO) with Gd doped ceria (CeO₂) (GDC), Cu-GDC cermet, lanthanum strontium cobalt ferrite (LSCF), or the like.

Without being limited thereto, the LSM may have Chemical Formula of La_{0.8}Sr_{0.2}MnO₃ and the LSCF may have Chemical Formula of La_{0.6}Sr_{0.4}Co_{0.2}Fe_{0.8}O₃.

The LSM has excellent mechanical reliability and very stabilized characteristics in the oxidation/reduction cycle.

The LSCF has high mixing ion/electric conductivity, such that it can be operated at intermediate and low temperature. For example, the LSCF has an ion conductivity of 0.01 and an electric conductivity of 200 S/cm² or more at 800° C. The LSCF has high thermal and chemical stability and has high catalyst reactivity for oxygen reduction.

The LSCF may be formed by using sol-gel or combustion spray pyrolysis.

The electrode base material may be a powder and the average particle size of the powder may be 5 to 20 nm. The specific surface area of the electrode base material may be 100 to 200 m²/g.

As set forth above, the electrode material for the fuel cell according to the exemplary embodiment of the present invention includes the spherical polystyrene particles. The polystyrene particles are removed during the firing process of the electrode base material. That is, the spherical polystyrene particles are combusted, leaving pores remaining in the sintering body of the electrode base material, during the heat treatment of the spherical polystyrene particles together with the electrode base material.

In order to improve the efficiency of the fuel cell, it is important to increase the porosity of the electrodes, through which oxygen and hydrogen permeate, and control the uniformity of the pores.

According to the related art, a carbon-based material has been used as a pore forming material; however, the carbon-based pore forming material has different combustion characteristics according to heat-treatment conditions, such that it is difficult to control the size and porosity of pores formed therewith. As the content of carbon black is increased, a contraction ratio is increased, such that it is difficult to control porosity. In addition, the carbon-based material is environmentally harmful.

The electrode material for the fuel cell according to the exemplary embodiment of the present invention uses spherical polystyrene as the pore forming material. A polystyrene resin may be formed of particles having a wide range of particle sizes and the average particle size thereof may be easily controlled. Accordingly, when the polystyrene resin is used, the porosity of the electrodes and the pore size can be easily controlled.

By controlling the average particle size and content of the spherical polystyrene particles, pores having a uniform size may be formed in the sintering body of the electrode base material and the control of the porosity may be facilitated.

Without being limited thereto, the average particle size of the spherical polystyrene particles may be 2 to 20 μm. When the average particle size of the spherical polystyrene particles is below 2 μm, it is difficult to form pores in the sintered body of the electrode base material. When the average particle size of the spherical polystyrene particles exceeds 20 μm, the strength of the sintered body may be degraded due to the excessive large pores.

In addition, without being limited thereto, the content of the spherical polystyrene particles may be 5 to 15 parts by weight per 100 parts by weight of the electrode base material.

The porosity of the polystyrene particles within the above-mentioned content range is linearly increased. This characteristic may be used to control the porosity within the electrodes according to a design purpose.

In addition, the electrode material for the fuel cell according to the exemplary embodiment of the present invention may include a binder resin. The binder resin bonds the electrode base material to assist the formation of the sintered body.

The content of the binder resin may be 5 to 30 parts by weight per 100 parts by weight of the electrode base material.

The binder resin may use a polymer resin having proton conductivity. For example, the polymer resin whose side chain has a cation exchanger selected from the group consisting of a sulfonic acid group, a carboxylic acid group, a phosphate group, a phosphonic acid group, and a derivative thereof may be used.

For example, a fluorine-based polymer, a benzimidazole-based polymer, a polyimide-based polymer, a polyetherimide-based polymer, a polyphenylene sulfide-based polymer, a polysulphone-based polymer, a polyether sulfone-based polymer, a polyether ketone-based polymer, a polyether-ether ketone-based polymer, a polyphenyl quinoxaline-based polymer may be used.

Hereinafter, a method of manufacturing a fuel cell using an electrode material therefor according to an exemplary embodiment of the present invention will be described.

First, an electrode material for a fuel cell according to an exemplary embodiment of the present invention is prepared to include an electrode base material and spherical polystyrene particles.

The electrode base material may use, but is not limited to, a metal-ceramic ion conductor.

The electrode base material is not specifically limited and may be, for example, lanthanum strontium manganite (LSM), Ni—YSZ cermet that is a mixture of nickel oxide (NiO) with yttria stabilized zirconia (YSZ), Cu—YSZ cermet, LSM-YSZ cermet, Ni—ScSZ cermet that is a mixture of nickel oxide (NiO) with scandia stabilized zirconia (ScSZ), Cu—ScSZ, Ni-GDC cermet that is a mixture of nickel oxide (NiO) with Gd doped ceria (CeO₂) (GDC), Cu-GDC cermet, lanthanum strontium cobalt ferrite (LSCF), or the like.

A slurry may be formed by mixing the electrode base material with the spherical polystyrene particles. The spherical polystyrene particles are used as a pore forming material and may be included at 5 to 15 parts by weight per 100 parts by weight of the electrode base material.

A solvent and a binder resin may be added to the slurry. The slurry may be mixed by ball-milling.

In addition, when the slurry is formed, ultrasonic waves may be applied thereto in order to prevent the particles of the electrode base material from being agglomerated.

The slurry may be formed as an electrode sheet by a tape-casting method. In this case, the thickness of the electrode sheet may be 35 to 45 μm.

A laminate may be formed by stacking the electrode sheet on one surface or both surfaces of an electrolyte sheet. The electrode sheet may be the anode electrode or the cathode electrode of the fuel cell.

The electrolyte sheet may be formed of a slurry including YSZ particles and may be formed to have a thickness of 1 to 5 μm by tape-casting the slurry.

In addition, the method of manufacturing the electrolyte sheet is not limited thereto, and the electrolyte sheet may be manufactured by various methods known in the art.

Thereafter, a sintered body may be formed by firing the laminate. The firing process may be performed step by step, according to the characteristics of individual components included in the slurry. For example, the solvent and the binder resin are removed at low temperature, and the electrode base material is sintered at high temperature to thereby remove the polystyrene particles.

The electrode base material is formed as the sintered body in the firing process and the polystyrene particles are combusted, leaving pores in the sintered body.

The firing process may be performed at 1000° C. or more, but is not limited thereto. More preferably, the firing process may be performed at 1300 to 1600° C.

When the firing temperature is below 1000° C., the sintering is not completely performed, the sintered body may be easily damaged. When the firing temperature is higher than 1600° C., the laminate may be bent during the firing process.

In order to prevent the laminate from being damaged such as bending or cracking during the firing process, a predetermined load is applied to the laminate to perform the sintering in a pressurized state.

For example, pressurized bodies having a predetermined size and weight are disposed on the top and bottom portions of the laminate, thereby pressurizing the laminate. The pressurized body may be made of a material that is stabilized so as not to chemically react with the laminate during the firing process and does not physically or chemically deform the pressurized body. In addition, the pressurized body may have a flat plate or a block shape corresponding to the laminate so as to uniformly pressurize the laminate.

The fuel cell, including the electrolyte membrane and the anode and cathode electrodes respectively formed on one surface and the other surface of the electrolyte membrane, may be formed during the firing process.

As set forth above, a unit cell may be manufactured by stacking the electrolyte sheet and the electrode sheet and simultaneously firing them.

Alternatively, a unit cell may be manufactured by individually firing the electrolyte sheet and the electrode sheet and bonding them.

FIG. 2 is a graph showing a pore formation ratio according to a firing temperature of an electrode material according to an exemplary embodiment of the present invention.

In more detail, the pore formation ratio of an electrode sintered body was measured at the sintering temperature of 1400° C., 1450° C., and 1500° C., respectively, by using Ni—YSZ cermet as an electrode base material and changing the content of spherical polystyrene particles.

Referring to FIG. 2, as the content of the spherical polystyrene particles is increased, the porosity of the electrode sintered body is linearly increased, such that the porosity of the electrode sintered body can be easily controlled.

On the other hand, in the case of carbon black, even if the content thereof is increased, the shrinkage ratio thereof is increased during the high-temperature sintering process. This may degrade porosity and cause a difficulty in controlling porosity.

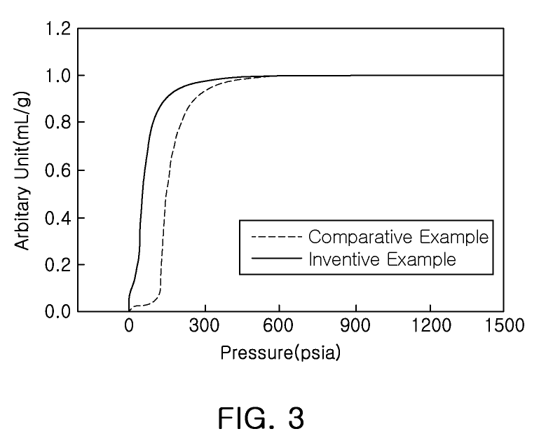

FIG. 3 is a graph showing gas permeability in an electrode formed of an electrode material according to an exemplary embodiment of the present invention.

In detail, the gas permeability of an electrode according to an Inventive Example was measured, in which the electrode was formed to include Ni—YSZ cermet as an electrode base material and spherical polystyrene particles having 7.5 parts by weight per 100 parts by weight of the electrode base material. The gas permeability of an electrode according to a Comparative Example was measured, in which the electrode was formed to include Ni—YSZ cermet as an electrode base material and carbon black having 7.5 parts by weight per 100 parts by weight of the electrode base material.

It could be appreciated from FIG. 3 that the electrode according to the Inventive Example had the gas permeability improved threefold or fourfold, as compared to the electrode according to the Comparative Example, within the same pressure at 300 psia or less.

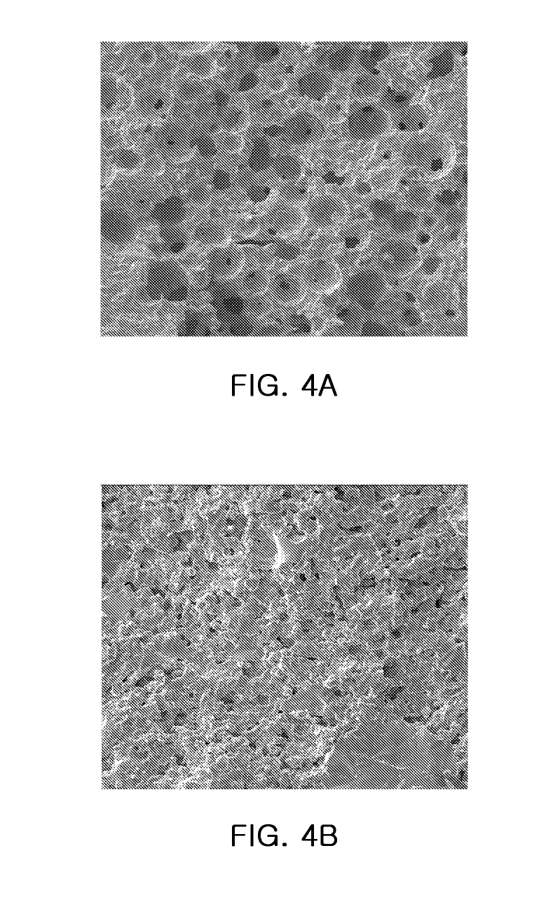

FIG. 4A is a scanning electron microscope (SEM) image of an electrode according to the Inventive Example, and FIG. 4B is a scanning electron microscope (SEM) image of an electrode according to the Comparative Example.

It could be appreciated from FIGS. 4A and 4B that the Inventive Example has improved uniformity in terms of the size and distribution of the pores, as compared to the Comparative Example.

The electrode material according to exemplary embodiments of the present invention uses polystyrene particles as a pore forming material, whereby the porosity of an electrode can be easily controlled and uniformity in terms of the distribution and size of pores can be achieved. As a result, the gas permeability and the ion conductivity of the electrode are improved.

As set forth above, an electrode material for a fuel cell according to exemplary embodiments of the present invention includes an electrode base material and spherical polystyrene particles. The spherical polystyrene particles are removed during the firing process of the electrode base material. That is, the spherical polystyrene particles are combusted, leaving pores in a sintered body formed of the electrode base material, during the heat treatment of the spherical polystyrene particles together with the electrode base material.

A polystyrene resin may be formed of particles having a wide range of particle sizes and the average particle size thereof can be easily controlled. In an electrode material using the polystyrene resin as a pore forming material, the porosity of an electrode and the pore size thereof can be easily controlled. That is, by controlling the average particle size and content of the spherical polystyrene particles, pores having a uniform size can be formed in a sintered body formed of the electrode base material and the control of porosity can be facilitated.

A fuel cell using the polystyrene resin has an increase in the porosity of the electrode, through which oxygen and hydrogen permeate, and the improved uniformity of porosity, thereby achieving improved efficiency.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrode material for a fuel cell, the electrode material comprising:
an electrode base material; and
spherical polystyrene particles forming pores in the electrode base material through heat treatment.

2. The electrode material of claim 1, wherein the polystyrene particles have an average particle size of 2 to 20 μm.

3. The electrode material of claim 1, wherein a content of the polystyrene particles is 5 to 15 parts by weight per 100 parts by weight of the electrode base material.

4. The electrode material of claim 1, wherein the electrode base material is an electrode material for a solid oxide fuel cell.

5. The electrode material of claim 1, wherein the electrode base material is a composite of a metal-ceramic ion conductor.

6. The electrode material of claim 1, wherein the electrode base material is at least one selected from the group consisting of lanthanum strontium manganite (LSM), Ni—YSZ cermet that is a mixture of nickel oxide (NiO) with yttria stabilized zirconia (YSZ), Cu—YSZ cermet, LSM-YSZ cermet, Ni—ScSZ cermet that is a mixture of nickel oxide (NiO) with scandia stabilized zirconia (ScSZ), Cu—ScSZ, Ni-GDC cermet that is a mixture of nickel oxide (NiO) with Gd doped ceria(CeO₂) (GDC), Cu-GDC cermet, and lanthanum strontium cobalt ferrite (LSCF).

7. The electrode material of claim 1, wherein the electrode base material is a powder.

8. The electrode material of claim 1, further comprising a binder resin.

9. A fuel cell comprising:
an electrolyte membrane; and
an anode electrode and a cathode electrode respectively formed on one surface and the other surface of the electrolyte membrane,
wherein at least one of the anode electrode and the cathode electrode is a sintered body formed of an electrode base material having a plurality of pores formed by a combustion of spherical polystyrene particles.

10. The fuel cell of claim 9, wherein the pores have an average particle size of 2 to 20 μm.

11. The fuel cell of claim 9, wherein the sintered body has a porosity of 15 to 50%.

12. The fuel cell of claim 9, wherein the electrode base material is an electrode material of a solid oxide fuel cell.

13. The fuel cell of claim 9, wherein the electrode base material is a composite of a metal-ceramic ion conductor.

14. A method of manufacturing a fuel cell, the method comprising:
manufacturing a slurry using an electrode material including an electrode base material and spherical polystyrene particles;
manufacturing an electrode sheet using the slurry;
firing the electrode sheet to form a sintered body of the electrode base material having pores formed by a combustion of the spherical polystyrene particles; and
placing the sintered body of the electrode base material on at least one of one surface and the other surface of an electrolyte membrane to be provided as an anode electrode or a cathode electrode.

15. The method of claim 14, wherein the polystyrene particles have an average particle size of 2 to 20 μm.

16. The method of claim 14, wherein a content of the polystyrene particles is 5 to 15 parts by weight per 100 parts by weight of the electrode base material.

17. The method of claim 14, wherein the electrode base material is an electrode material for a solid oxide fuel cell.

18. The method of claim 14, wherein the electrode base material is a composite of a metal-ceramic ion conductor.

19. The method of claim 14, wherein the electrode base material is a powder.

20. The method of claim 14, wherein the electrode material further includes a binder resin.

21. The method of claim 14, wherein the firing of the electrode sheet is performed at 1000° C. or more.
